(19) United States
(12) Patent Application Publication
(10) Pub. No.: US 2008/0235066 A1
(43) Pub. Date: Sep. 25, 2008

(54) TASK MANAGEMENT DEVICE, TASK MANAGEMENT METHOD, AND TASK MANAGEMENT PROGRAM

(76) Inventor: Hiroko Mano, Tokyo (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/050,430

(22) Filed: Mar. 18, 2008

(30) Foreign Application Priority Data
Mar. 19, 2007 (JP) 2007-071604
Feb. 21, 2008 (JP) 2008-040213

(51) Int. Cl. G06F 17/50

(52) U.S. Cl. 705/7

(57) ABSTRACT

In a task management device which manages a plurality of tasks arranged in a hierarchical structure and stored in a storage unit, task definition data which describes contents of a task is input. Task information of the task is generated from the input task definition data. The generated task information is stored into the storage unit. A request for generating a set of lower-level tasks from the task information is received. When the request is received, task information of each of the set of lower-level tasks is generated based on a result of analysis of the task definition data for the task information which analysis is performed in accordance with predetermined rules used to define contents of each lower-level task.

### BACKGROUND OF THE INVENTION

1. Field of the Invention

This invention relates to a task management device which manages a plurality of tasks arranged in a hierarchical structure.

2. Description of the Related Art

In recent years, projects, such as a product development, are increasingly complicated because they are comprised of many tasks (operation processes) and many people in pertinent sections and departments of a company participate in one project. It is important for the company to manage such complicated project efficiently in order to carry out the project.

Under the situations, a task management system which manages a project as a plurality of tasks arranged in a hierarchical structure is used as a system which supports management of the project. For example, a task management system which is adapted for generating detailed operation items specific to a project, based on the pre-defined task composition and the configuration information of a development object is proposed in order to manage the tasks efficiently (see Japanese Laid-Open Patent Application No. 2004-110102). Moreover, a task management system which is adapted for generating a list of products to be generated and corresponding task information based on the pre-defined process definition which defines the fundamental processes of a system development is proposed in order to manage the tasks efficiently (see Japanese Laid-Open Patent Application No. 2000-215038).

In this manner, the conventional task management systems define task information concerning the tasks (which constitute the project) beforehand and manage the task information in a unified manner in order to realize efficient project management.

However, the conventional task management systems disclosed in Japanese Laid-Open Patent Application Nos. 2004-110102 and 2000-215038 are applicable only to the routine tasks that can be clearly defined to a certain extent at the time of planning of a project. In the cases of the conventional task management systems, the whole task composition must be decided prior to the time of starting of the project.

Specifically, in the case of the system disclosed in Japanese Laid-Open Patent Application No. 2004-110102, it is necessary to define beforehand the task composition and the configuration information of a development object, in order to generate detailed operation items specific to the project. In the case of the system disclosed in Japanese Laid-Open Patent Application No. 2000-215038, it is necessary to generate beforehand the process definition that defines fundamental processes of a system development, in order to generate a list of products to be generated and corresponding task information.

Therefore, when the task composition, such as that of non-routine tasks, is changed during the progress of a project, it is necessary for the conventional task management systems to generate re-definition of a relevant portion of the task composition with respect to the changes.

Since the actual project generally is comprised of many tasks and many people in pertinent sections and departments of a company participate in the project, the number of non-routine tasks for which flexible countermeasures against their changes must be taken is larger than the number of routine tasks among those of the project. Such changes of the non-routine tasks are difficult to foresee, and the whole task composition including the non-routine tasks is difficult to grasp. Since the task composition of non-routine tasks is fixed gradually through the progress of a project, it is inevitable that the task composition of non-routine tasks be changed in the progress of the project.

Therefore, the conventional task management systems which must define strictly the whole task composition of a project prior to the time of starting of the project are not appropriate for managing a plurality of tasks of a project including non-routine tasks. Once the task composition of the non-routine tasks is changed in the progress of the project, generating redefinition of the relevant portion of the task composition in a manner separate from the already registered tasks using either of the conventional task management systems may impose uneasiness on the task managing person before starting execution of the project.

### SUMMARY OF THE INVENTION

According to one aspect of the invention, there is disclosed an improved task management device and method in which the above-described problems are eliminated.

According to one aspect of the invention there is disclosed a task management device which manages a plurality of tasks arranged in a hierarchical structure and allows a user to easily add and register a task to the existing tasks by simple operation.

In an embodiment of the invention which solves or reduces one or more of the above-mentioned problems, there is disclosed a task management device which manages a plurality of tasks arranged in a hierarchical structure and stored in a storage unit, the task management device comprising: a task definition data input unit configured to input task definition data which describes contents of a task; a task information generating unit configured to generate task information of the task from the task definition data input by the task definition data input unit; a task information storing unit configured to store the task information generated by the task information generating unit, into the storage unit; and a receiving unit configured to receive a request for generating a set of lower-level tasks from the task information, wherein, when the request is received by the receiving unit, the task information generating unit generates task information of each of the set of lower-level tasks, based on a result of analysis of the task definition data for the task information which analysis is performed in accordance with predetermined rules used to define contents of each lower-level task.

In the task management device of the present invention, the task definition data in which the information concerning the tasks and the information indicating the hierarchical relationship between the tasks are defined according to the predetermined rules is input. The task information in which the information concerning the hierarchical structure is added to the extracted information concerning the tasks based on a result of a syntactic analysis result of the input task definition data is automatically generated. In the task management which manages the plurality of tasks arranged by the hierarchical structure, it is possible to allow a user to easily add and register a task to the existing tasks by simple operation.

The above-mentioned task management device may be arranged so that the task information generating unit is configured to add information identifying each lower-level task to task information of the lower-level task containing a character string which is extracted from the task definition data and indicates contents of the lower-level task, so that the task information of each lower-level task is generated.

The above-mentioned task management device may be arranged so that the predetermined rules include information indicating a hierarchical relationship between lower-level tasks, and the task information generating unit is configured to add information indicating a hierarchical relationship between the task and each low-level task to the task information of the lower-level task containing the character string, based on the information included in the predetermined rules, so that the task information of each lower-level task is generated.

The above-mentioned task management device may be arranged so that wherein the receiving unit is configured to receive a request having a selected range of the task definition data for generating a set of lower-level tasks, and the task information generating unit is configured to perform analysis of the selected range of the task definition data in accordance with the predetermined rules.

In the task management device of the present invention, even when the information indicating the hierarchical relationship between the tasks is indefinite, it is possible to generate task information for managing the tasks and register the generated task information provisionally. Therefore, at a time the information indicating the hierarchical relationship is fixed, syntactic analysis of the task definition data is performed, and task information in which the information concerning the hierarchical structure is added to the extracted information concerning the tasks, based on a result of the syntactic analysis is automatically generated, so that the provisionally registered task information can be registered as formal task information.

In an embodiment of the invention which solves or reduces one or more of the above-mentioned problems, there is disclosed a task management method which manages a plurality of tasks arranged in a hierarchical structure and stored in a storage unit, the method comprising the steps of: inputting task definition data which describes contents of a task; generating task information of the task from the input task definition data; storing the generated task information into the storage unit; and receiving a request for generating a set of lower-level tasks from the task information, wherein, when the request is received in the receiving step, task information of each of the set of lower-level tasks is generated in the generating step based on a result of analysis of the task definition data for the task information which analysis is performed in accordance with predetermined rules used to define contents of each lower-level task.

In an embodiment of the invention which solves or reduces one or more of the above-mentioned problems, there is disclosed a computer-readable program which, when executed by a computer, causes the computer to perform a task management method which manages a plurality of tasks arranged in a hierarchical structure and stored in a storage unit, the method comprising the steps of: inputting task definition data which describes contents of a task; generating task information of the task from the input task definition data; storing the generated task information into the storage unit; and receiving a request for generating a set of lower-level tasks from the task information, wherein, when the request is received in the receiving step, task information of each of the set of lower-level tasks is generated in the generating step based on a result of analysis of the task definition data for the task information which analysis is performed in accordance with predetermined rules used to define contents of each lower-level task.

According to the embodiments of the task management device, method and program of the invention, it is possible to manage a plurality of tasks arranged in a hierarchical structure and allow a user to easily add and register a task to the existing tasks by simple operation.

### BRIEF DESCRIPTION OF THE DRAWINGS

Other objects, features and advantages of the present invention will be apparent from the following detailed description when reading in conjunction with the accompanying drawings.

FIG. 1 is a diagram showing the hardware composition of a task management device in a first embodiment of the invention.

FIG. 2 is a block diagram showing the composition of respective units which constitute the main functions of the task management device of the first embodiment.

FIG. 3 is a diagram showing an example of a task definition data input in the first embodiment of the invention.

FIG. 4 is a diagram showing an example of a data structure of task definition data and an example of a task definition rule in the first embodiment of the invention.

FIG. 5 is a diagram showing an example of a data structure of task information in the first embodiment of the invention.

FIG. 6 is a diagram showing an example of task management operation (input of task definition data) in the first embodiment of the invention.

FIG. 7 is a diagram showing an example of task information generated after the input in the first embodiment of the invention.

FIG. 8 is a diagram showing an example of task management operation (viewing of task information) in the first embodiment of the invention.

FIG. 9 is a diagram showing an example of task management operation (input of task definition data) in the first embodiment of the invention.

FIG. 10 is a diagram showing an example of task information generated after the input in the first embodiment of the invention.

FIG. 11 is a diagram showing an example of task management operation (viewing of task information) in the first embodiment of the invention.

FIG. 12 is a diagram showing an example of task management operation (decomposing into lower-level tasks) in the first embodiment of the invention.

FIG. 13 is a diagram showing an example of task information generated after the decomposing in the first embodiment of the invention.

FIG. 14 is a diagram showing an example of task management operation (viewing of task information) in the first embodiment of the invention.

FIG. 15 is a flowchart for explaining the fundamental operation procedure performed by the task management device of the first embodiment.

FIG. 16 is a flowchart for explaining the task information generation processing performed by the task management device of the first embodiment.

FIG. 17 is a diagram showing an example of a task definition data input in a modification of the first embodiment of the invention.

FIG. 18 is a diagram showing an example of task information generated in a modification of the first embodiment of the invention.

FIG. 19 is a diagram showing an example of a task management system in a modification of the first embodiment of the invention.

### DETAILED DESCRIPTION OF PREFERRED EMBODIMENTS

Before describing the embodiments of the invention, the fundamental principle of the invention will be explained in order to facilitate understanding of the invention. The task management device in an embodiment of the invention is adapted for eliminating the previously mentioned problem in the management of non-routine tasks. In the task management device in an embodiment of the invention, even when the information indicating the hierarchical relationship between the tasks is indefinite in the progress of the project, it is possible to generate task information for managing the tasks and register the generated task information provisionally. Therefore, at a time the information indicating the hierarchical relationship is fixed, syntactic analysis of the task definition data is performed, and task information in which the information concerning the hierarchical structure is added to the extracted information concerning the tasks, based on a result of the syntactic analysis is automatically generated, so that the provisionally registered task information can be registered as formal task information.

A description will be given of the embodiments of the invention with reference to the accompanying drawings.

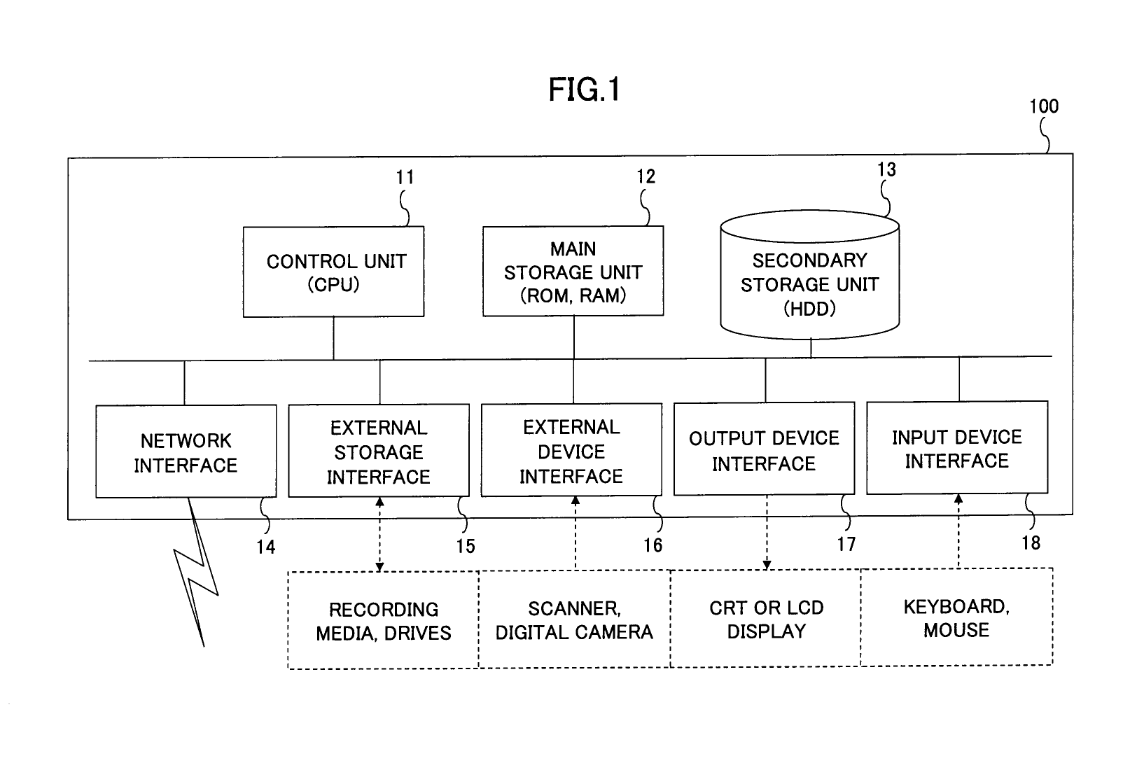

The hardware composition of a task management device 100 in a first embodiment of the invention will be explained with reference to FIG. 1. FIG. 1 shows the hardware composition of the task management device 100 of this embodiment.

As shown in FIG. 1, the task management device 100 of this embodiment includes a control unit 11, a main storage unit 12, a secondary storage unit 13, a network interface (I/F) 14, an external storage interface (I/F) 15, an external device interface (I/F) 16, an output device interface (I/F) 17, and an input device interface (I/F) 18.

The control unit (CPU: central processing unit) 11 controls respective units of the task management device 100 of this embodiment, including the main storage unit 12, the secondary storage unit 13, and the network I/F 14 which will be described below. The control unit 11 is a unit which executes a program stored in the main storage unit 12. In accordance with the executed program, the control unit 11 receives data from the input unit or the storage unit, performs computations and processing of the data, and outputs the processed data to the output device or the storage unit (for example, an image of characters input through a keyboard is displayed on a display unit).

The main storage unit 12 (ROM: read-only memory, RAM: random access memory) stores the program executed by the control unit 11, and stores related data (which, in some cases, are temporarily stored). In the ROM, the program executed by the control unit 11 and the related data are stored, and the program and the related data from the ROM are loaded (or developed) onto the RAM by the control unit 11 if needed. The loaded data on the RAM are calculated and processed by the control unit 11 according to the program.

The secondary storage unit (HDD: hard disk drive) 13 is a storage unit which stores the OS (operating system) which is the basic software, application programs, etc. together with related data. In the secondary storage unit 13, various items of information (for example, task information) which are managed by the task management device 100 of this embodiment are also stored, and the various items of information are managed in conjunction with a database (DB), a file system (FS), etc.

The network I/F 14 is an interface between the task management device 100 of this embodiment and a peripheral device having a communication unit and connected via a network, such as LAN (local area network) or WAN (wide area network), which is built by data transmission lines, such as wired and/or wireless communication lines.

The external storage I/F 15 is an interface between the task management device 100 of this embodiment and an external storage unit (for example, a recording-medium drive) connected via a data transmission line, such as USB (universal serial bus).

The external device I/F 16 is an interface between the task management device 100 of this embodiment and an external input device (for example, an external HDD or a USB memory) connected via a data transmission line, such as USB.

The task management device 100 of this embodiment performs transmission of data to and receiving of data from an external device through these interfaces and performs reading/writing of various data through these interfaces.

The output device I/F 17 is an interface between the task management device 100 of this embodiment and an output device (for example, CRT (cathode ray tube) or LCD (liquid crystal display) display unit) connected via a data transmission line, such as a leased cable.

The input device I/F 18 is an interface between the task management device 100 of this embodiment and an input device (for example, a keyboard and a mouse) connected via a data transmission line, such as USB.

Thus, the task management device 100 of this embodiment executes the program stored in the main storage unit 12 or the secondary storage unit 13, and realizes the task management function by controlling the respective units.

Next, the functional composition of the task management function provided in the task management device 100 of this embodiment will be explained.

The task management function provided in the task management device 100 of this embodiment generally includes a task definition data input unit, a task information generating unit, and a task information storing unit.

The task definition data input unit has a function of providing an input user interface (UI) for a user to input task definition data in which information concerning tasks and information indicating a hierarchical relationship between tasks are defined according to predetermined rules. The task information generating unit has a function of performing syntactic analysis of the task definition data input through the input user interface (UI) and generating automatically task information in which the information concerning the hierarchical structure is added to the extracted information concerning the tasks, based on a result of the syntactic analysis. The task information storing unit has a function of storing the task information into a non-volatile memory unit, such as the secondary storage unit 13.

In this manner, in order to realize the task management function provided in the task management device 100 of this embodiment, the program for realizing the respective units mentioned above is loaded onto the RAM of the main storage unit 12, and executed by the control unit 11. Thus, in the task management which manages a plurality of tasks arranged in a hierarchical structure, the user is allowed to easily add and register a task to the existing tasks by simple operation.

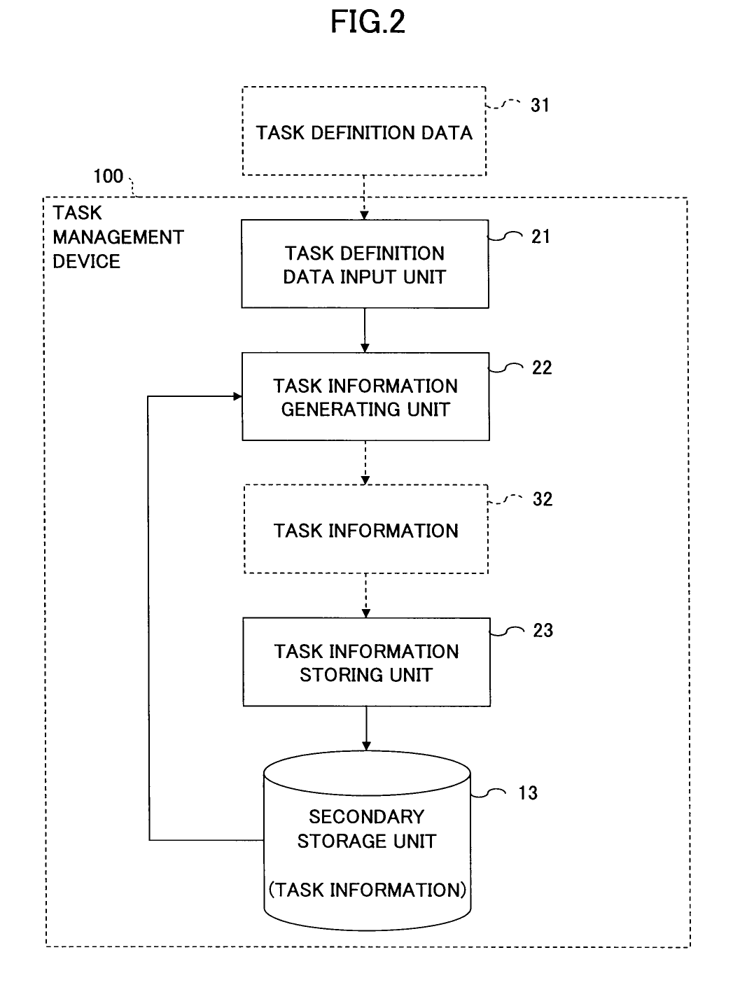

Next, the respective units which constitute the main modules of the task management function provided in the task management device 100 of this embodiment will be explained with reference to FIGS. 2-5.

FIG. 2 shows the composition of the respective units which constitute the main functions provided in the task management device 100 of the first embodiment of the invention.

The task management function provided in the task management device 100 of this embodiment is realized by the main functions of the task management device 100 (which include respective functions of task definition data input, task information generating, and task information storing).

As shown in FIG. 2, the task management function provided in the task management device 100 of this embodiment includes a task definition data input unit 21, a task information generating unit 22, and a task information storing unit 23.

The task definition data input unit 21 provides an input user interface (UI) for a user to input task definition data 31 in which information concerning tasks and information indicating a hierarchical relationship between tasks are defined according to predetermined rules.

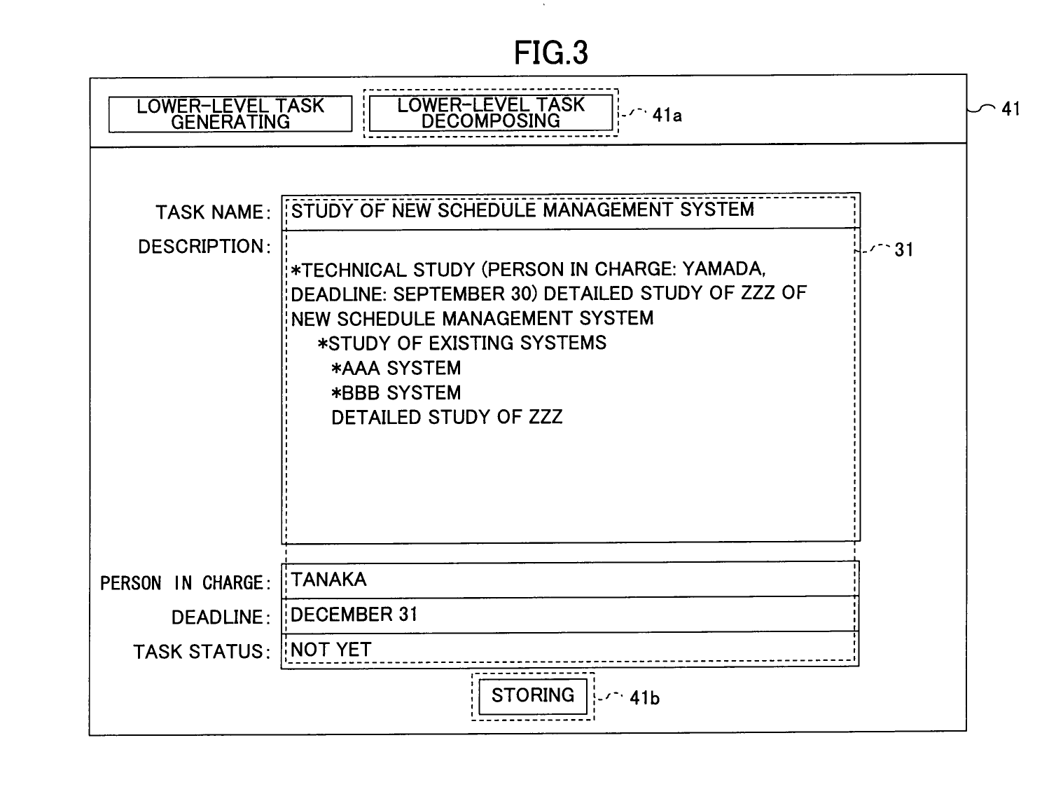

FIG. 3 shows an example of a task definition data input in the first embodiment of the invention.

The task definition data input unit 21 displays an input user interface 41 (called input UI 41) as shown in FIG. 3 on an output device, such as a display device, and provides a user with the environment in which the task definition data 31 is input into the task management device 100 through the input device, such as a keyboard or a mouse.

For example, the input UI 41 shown in FIG. 3 includes respective text boxes to which the user can input the following items: “task name” indicating the name of a task; “task description” describing the contents of the task; “person in charge” indicating the person in charge who performs the task (operation); “deadline” indicating the time limit by which the task is to be completed; and “task status” indicating the current state of the task.

Specifically, the example of FIG. 3 which is input into the respective text boxes by the user using the input device, such as a keyboard, shows that the person in charge “Tanaka” is scheduled to complete the task “study of new schedule management system” shown in the “task description item (task definition data 31)” by the deadline “December 31”.

If the storing button 41b in the input UI 41 is chosen by the user using the pointing device, such as a mouse, the input data of the respective items together with a request for registering the task of “study of new schedule management system” are transmitted to the task information generating unit 22 via the main storage unit 12.

If the lower-level task decomposing button 41a in the input UI 41 is chosen, the input task definition data 31 together with a request for decomposing the task definition data 31 into lower-level tasks located under the task of “study of new schedule management system” (the lower-level tasks will be added) are transmitted to the task information generating unit 22 via the main storage unit 12.

Referring back to FIG. 2, the task definition data input unit 21 provides the user with the input UI 41 which inputs the various data containing the task definition data 31 which is the item of “task description”, and requests the post-processing of the input data. Moreover, in response to the requests of data processing (for example, task registration and lower-level task addition) received from the input UI 41, the task definition data input unit 21 performs the transmission of the task registration request or lower-level task decomposing request to the task information generating unit 22, and performs the transmission of the task definition data 31 to the task information generating unit 22. The data of the respective items containing the task definition data 31 are stored in the RAM of the main storage unit 12 temporarily.

Accordingly, the task management device 100 of this embodiment can provide the environment in which the user is allowed to perform flexibly the task management operation of non-routine tasks, such as new task registration and lower-level task addition to the existing tasks.

In accordance with the requests of data processing (for example, new task registration and lower-level task addition) received from the task definition data input unit 21, the task information generating unit 22 performs syntactic analysis of the task definition data 31 (temporarily stored in the RAM of the main storage unit 12) input via the item of “task description” of the input UI 41 provided by the task definition data input unit 21. The task information generating unit 22 automatically generates task information in which the identification information identifying the tasks and the information concerning the hierarchical structure indicating the levels of the tasks in the hierarchical structure are added to the extracted information concerning the tasks, based on the result of the syntactic analysis.

Briefly speaking, the task information generating unit 22 includes an information extracting unit and an information adding unit. The information extracting unit extracts the information concerning the tasks defined according to the predetermined rules, from the input task definition data 31. The information adding unit adds the identification information of the tasks and the information concerning the hierarchical structure, to the extracted information concerning the tasks.

As mentioned above, the task information generating unit 22 performs syntactic analysis of the input task definition data 31 according to the predetermined rules used when defining the information concerning the tasks (“syntactic analysis” means the analysis of text composition containing character strings).

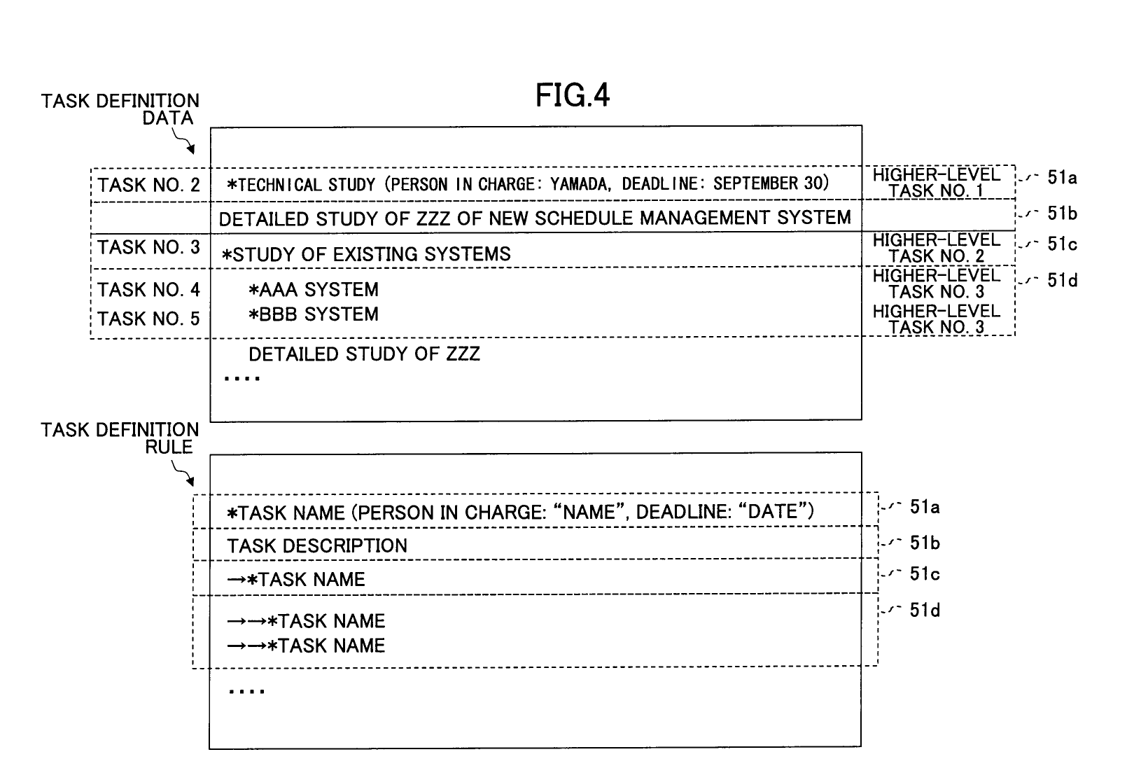

FIG. 4 shows an example of the data structure of the task definition data 31 and an example of the task definition rule in the first embodiment of the invention.

In the input task definition data 31, the information concerning the tasks and the information indicating the hierarchical relationship between the tasks are defined according to the predetermined rules, like the “task definition rule” shown in FIG. 4 (the lower part). For example, when the information concerning the tasks and the information indicating the hierarchical relationship between the tasks are input by the user via the item of “task description” in the input UI 41 of FIG. 3 according to the predetermined rules (task definition rule), each information shown in FIG. 4 is defined as the task definition data 31.

The example of the “task definition rule” shown in FIG. 4 (the lower part) shows the following rules.

### Task Definition Rules

### (1) Information Concerning Task

(1-A) the information concerning task is expressed by a character string 51a which begins with the character “*” at the beginning of a line as follows.

*Task Name (person in charge: Name, deadline: Date)

(1-B) one task is expressed by a line feed at the end of the character string 51a.
(1-C) the composition of the character string 51a may be expressed by a “task name” only, such as in character strings 51c and 51d.
(1-D) the remarks 51b concerning a task does not begin with the character “*” at the beginning of a line.

### (2) Information Indicating Hierarchical Relationship Between Tasks

(2-A) the hierarchical structure between tasks is expressed by the regular indentation by a space (in FIG. 4, ‘->’ denotes a space).

The task information generating unit 22 performs syntactic analysis of the input task definition data 31 according to the predetermined rules (task definition rule) of defining the information concerning the tasks and the information indicating the hierarchical relationship between the tasks as shown in FIG. 4 (the lower part), and extracts the information concerning the tasks based on the result of the syntactic analysis (or the function of the information extracting unit).

Suppose that syntactic analysis of the task definition data 31 of FIG. 4 (the upper part) is performed according to the task definition rule shown in FIG. 4 (the lower part). In this case, the information extracting unit of the task information generating unit 22 extracts, from the character string 51a “*technical study (person in charge: Yamada, deadline: September 30)”, which is located at the first line and ends with a line feed, “technical study” of the “task name” item, “Yamada” of the “person-in-charge name” item, and “September 30” of the “deadline” item according to the task definition rules of the above (1-A) and (1-B). As a result, it is possible to extract the information concerning the task that “Yamada” is scheduled to complete the task “technical study” by the deadline “September 30”.

Moreover, the information extracting unit of the task information generating unit 22 extracts, from the character string 51b “detailed study of ZZZ of new schedule management system” in the next line, the description describing the contents of the task “technical study” according to the task definition rule of the above (1-D).

Moreover, the information extracting unit of the task information generating unit 22 extracts, from the character string 51c “*study of existing systems” and the character strings 51d “*AAA system” and “*BBB system”, “study of existing systems” of the “task name” item and “AAA system”, “BBB system” of the “task name” items in according to the task definition rules of the above (1-A) and (1-C), respectively. As a result, it is possible to extract the information concerning the tasks “study of existing systems”, “AAA system” and “BBB system”.

Referring back to FIG. 2, the task information generating unit 22 stores the data of the extracted information concerning the tasks into the RAM of the main storage unit 12 temporarily.

The task information generating unit 22 adds the identification information identifying the tasks (for example, a task number assigned at a time of task addition) to the information concerning the tasks (which is extracted from the input task definition data 31) according to the predetermined rules (task definition rule) for defining the information concerning the tasks as shown in FIG. 4 (the lower part). Moreover, if there is a hierarchical relationship between the extracted tasks and another task (which is located in a higher level over the extracted tasks and called “higher-level task”) as a result of the syntactic analysis of the input task definition data 31 which is performed according to the predetermined rules (task definition rule) for defining the information indicating the hierarchical relationship between the tasks as shown in FIG. 4 (the lower part), the task information generating unit 22 adds the information concerning the hierarchical structure (for example, task number of a higher-level task) indicating the level of the task in the hierarchical structure (the function of the information adding unit).

Next, the method of adding the identification information identifying the tasks performed by the task information generating unit 22 will be explained.

Suppose that syntactic analysis of the task definition data 31 of FIG. 4 (the upper part) is performed according to the task definition rules shown in FIG. 4 (the lower part). In this case, the information adding unit of the task information generating unit 22 adds a task number in the order of extraction to each task which is extracted by the information extracting unit according to the task definition rule of the above (1-A). The task number assigned at this time is the next number of the task number assigned to the last task which is previously extracted as a result of the syntactic analysis of the task definition data 31.

When the task number previously assigned to the last task extracted as the result of the previous syntactic analysis of the task definition data 31 is ‘1’, the information adding unit adds the task number ‘2’ to the information concerning the task “technical study” first extracted as a result of the current syntactic analysis as identification information. Similarly, the information adding unit adds the task number ‘3’ to the information concerning the task “study of existing systems” extracted next, adds the task number ‘4’ to the information concerning the task “AAA system”, and adds the task number ‘5’ to the information concerning the task “BBB system”. And the last task number ‘5’ is stored in the non-volatile memory unit, such as the secondary storage unit 13. Therefore, the task number assigned next time to the task which will be extracted first as a result of the syntactic analysis of the task definition data 31 is set to ‘6’.

Next, the method of adding the information concerning the hierarchical structure by the task information generating unit 22 will be explained.

Suppose that syntactic analysis of the task definition data 31 of FIG. 4 (the upper part) is performed according to the task definition rules shown in FIG. 4 (the lower part). In this case, the information adding unit of the task information generating unit 22 determines whether a higher-level task, located over the extracted task, exists (or the hierarchical relationship between the tasks), based on the information indicating the hierarchical relationship between the tasks analyzed according to the task definition rule of the above (2-A) used when the information concerning the tasks is extracted by the information extracting unit. When it is determined that a higher-level task exists (a task located in a higher level over the extracted task), the information adding unit of the task information generating unit 22 adds the identification information of the higher-level task as the information concerning the hierarchical structure of the extracted task.

The identification information of the higher-level task added at this time is a task number for identifying the task added to each extracted task by the information adding unit.

Since there is no space at the beginning of the line of the character string 51a (the information indicating the hierarchical relationship between tasks), the information adding unit determines that no higher-level task exists over the task of “technical study” first extracted as a result of the current syntactic analysis from among the plurality of tasks defined in the task definition data 31. The information adding unit adds the task number ‘1’ of the highest-level task (for example, the task “study of new schedule management system” in FIG. 3) which is in the highest level among all the tasks defined in the task definition data 31, to the information concerning the task “technical study” as the information concerning the hierarchical structure.

Since there are one space and one indentation at the beginning of the line of the character string 51c, the information adding unit determines that a higher-level task does exist over the task of “study of existing systems” next extracted. The information adding unit adds the task number ‘2’ of the higher-level task “technology study” to the information concerning the task “study of existing systems” as the information concerning the hierarchical structure.

Since there are two spaces and one indentation at the beginning of the line of the character string 51c, the information adding unit determines that a higher-level task over the subsequently extracted tasks of “AAA system” and “BBB system” does exist. The information adding unit adds the task number ‘3’ of the higher-level task “study of existing systems” to the information concerning the tasks of “AAA system” and “BBB system” as the information concerning the hierarchical structure.

Referring back to FIG. 2, the task information generating unit 22 stores the data of the identification information (for example, task numbers) to be added, and the data of the information concerning the hierarchical structure (for example, task numbers of higher-level tasks) into the RAM of the main storage unit 12 temporarily.

In this manner, the task information generating unit 22 performs syntactic analysis of the input task definition data 31 according to the predetermined rules of defining the information concerning the tasks and the information indicating the hierarchical relationship between the tasks. Moreover, the task information generating unit 22 automatically generates the task information in which the identification information (for example, task numbers) and the information indicating the hierarchical structure of the tasks (for example, task numbers of higher-level tasks) are added to the extracted information concerning the tasks based on the result of the syntactic analysis. The generated task information is stored into the RAM of the main storage unit 12.

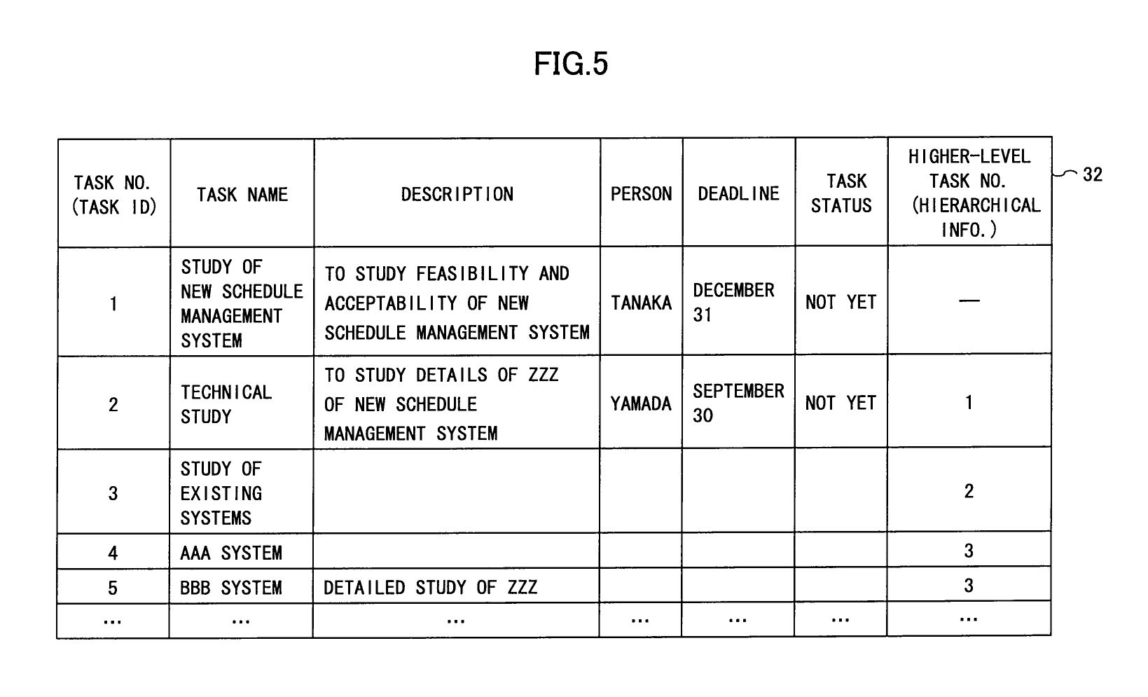

FIG. 5 shows an example of the data structure of the task information 32 in the first embodiment of the invention.

The task information generating unit 22 generates the task information 32 as shown in FIG. 5 by using the above-mentioned units described with FIG. 4, and transmits the generated task information 32 to the task information storing unit 23.

In this manner, the task management device 100 of this embodiment allows the user to easily perform addition and registration of a plurality of tasks collectively, based on the task definition data in which the information concerning the tasks and the information indicating the hierarchical relationship between the tasks are defined.

Referring back to FIG. 2, the task information storing unit 23 stores the task information 32 generated by the task information generating unit 22 and the data of the respective items input via the input UI 41 provided by the task definition data input unit 21, into the non-volatile memory unit, such as the secondary storage unit 13.

The task information storing unit 23 stores the task information 32 so that the data of the respective items contained in the task information 32 are held in the predetermined areas of the non-volatile memory unit, such as the secondary storage unit 13. The task information storing unit 23 stores the task information 32 so that the data of the respective items input via the input UI 41 are held in the predetermined areas of the non-volatile memory unit, such as the secondary storage unit 13. The predetermined areas of the non-volatile memory unit mean the data area of the respective items, such as “task number (identification information)”, “task name”, “description (remarks)”, “person in charge”, “deadline”, “status”, and “higher-level task number (hierarchical structure information)” which constitutes the data of table format as shown in FIG. 5. Therefore, the task information storing unit 23 can store the data in the data area corresponding to each item.

In this manner, the task management device 100 of this embodiment can manage the plurality of registered tasks.

The task management device 100 of this embodiment carries out the functions of the respective units mentioned above according to the following procedures.

### (Procedure 1)

First, in the task management device 100 of this embodiment, using the input UI 41 provided by the task definition data input unit 21, the user is allowed to input the various data which contains the task definition data 31 in which the information concerning the tasks and the information indicating the hierarchical relationship between the tasks are defined according to the predetermined rules.

Next, the task management device 100 causes the task definition data input unit 21 to transmit the request for registration of tasks to the task information generating unit 22 in response to the request of data processing (for example, task registration) received together with the data input from the input UI 41, and store the data of the respective items containing the task definition data 31 into the RAM of the main storage unit 12 temporarily.

### (Procedure 2)

Next, the task management device 100 causes the task information generating unit 22 to generate automatically the task information 32 in which the identification information identifying the tasks (for example, task numbers) and the information concerning the hierarchical structure (for example, task numbers of higher-level tasks) are added to the extracted information concerning the tasks.

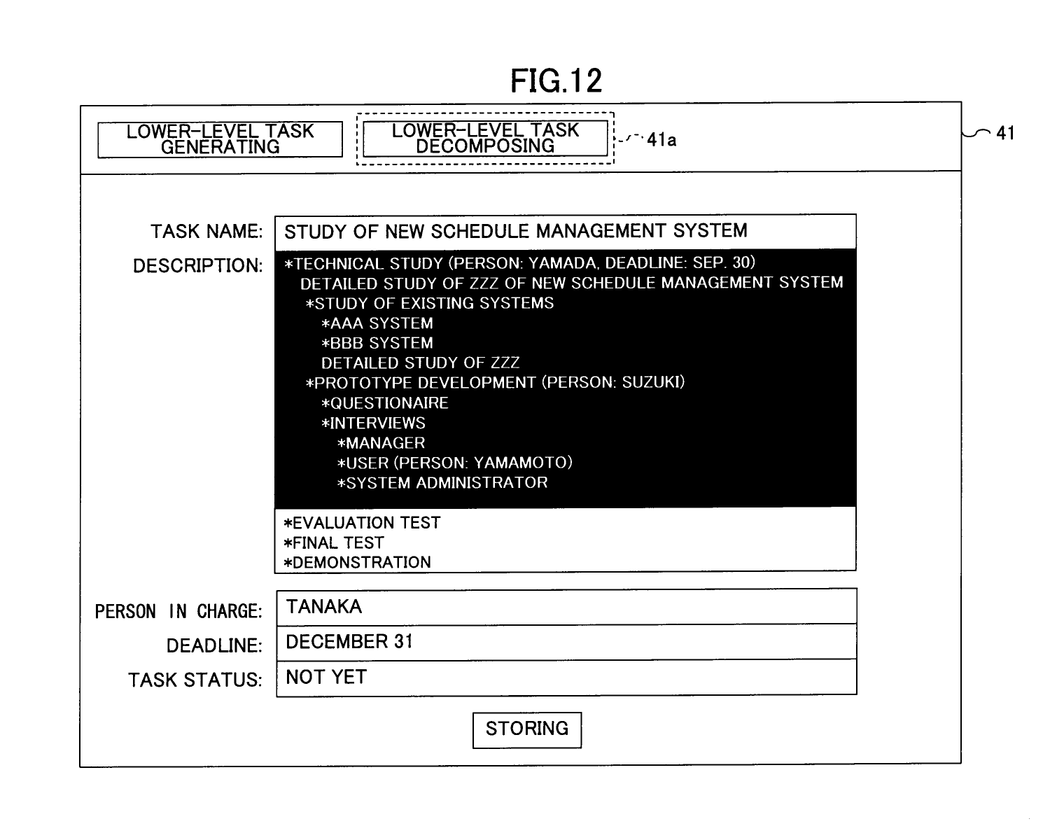

Subsequently, when the lower-level task decomposing button 41a in the input UI 41 is selected by the user (refer to FIG. 12), the task management device 100 causes the task information generating unit 22 to perform syntactic analysis of the task definition data 31, temporarily stored in the RAM of the main storage unit 12 by the task definition data input unit 21, in response to the request of data processing (task registration and lower-level task addition) received from the task definition data input unit 21. At this time, the task information generating unit 22 performs syntactic analysis of the input task definition data 31 according to the predetermined rules (task definition rule) of defining the information concerning the tasks.

Next, the task management device 100 causes the task information generating unit 22 to extract the information concerning the tasks based on the result of the syntactic-analysis result (the information extracting unit). The task information generating unit 22 stores the data of the extracted information concerning the tasks into the RAM of the main storage unit 12 temporarily.

Next, the task management device 100 causes the task information generating unit 22 to add the identification information identifying the tasks (task numbers) to the extracted information concerning the tasks based on the syntactic-analysis result. The task management device 100 causes the task information generating unit 22 to add also the information indicating the hierarchical structure indicating the levels of the tasks in the hierarchical structure (task numbers of higher-level tasks), when it is determined that a hierarchical relationship exists between the extracted task and other tasks (a higher-level task exists over the extracted task), as a result of the syntactic analysis of the input task definition data 31 according to the predetermined rules (task definition rule) for defining the information indicating the hierarchical relationship between the tasks (information adding unit).

The task information generating unit 22 stores the data of the identification information (task numbers) and the data of the information concerning the hierarchical structure (task numbers of higher-level tasks) into the RAM of the main storage unit 12 temporarily.

As a result, the task information 32 which contains the information concerning the tasks, which is the extracted data, and the identification information (task numbers) and the information concerning the hierarchical structure (task numbers of higher-level tasks), which are the addition data, is stored into the RAM of the main storage unit 12 in the task management device 100.

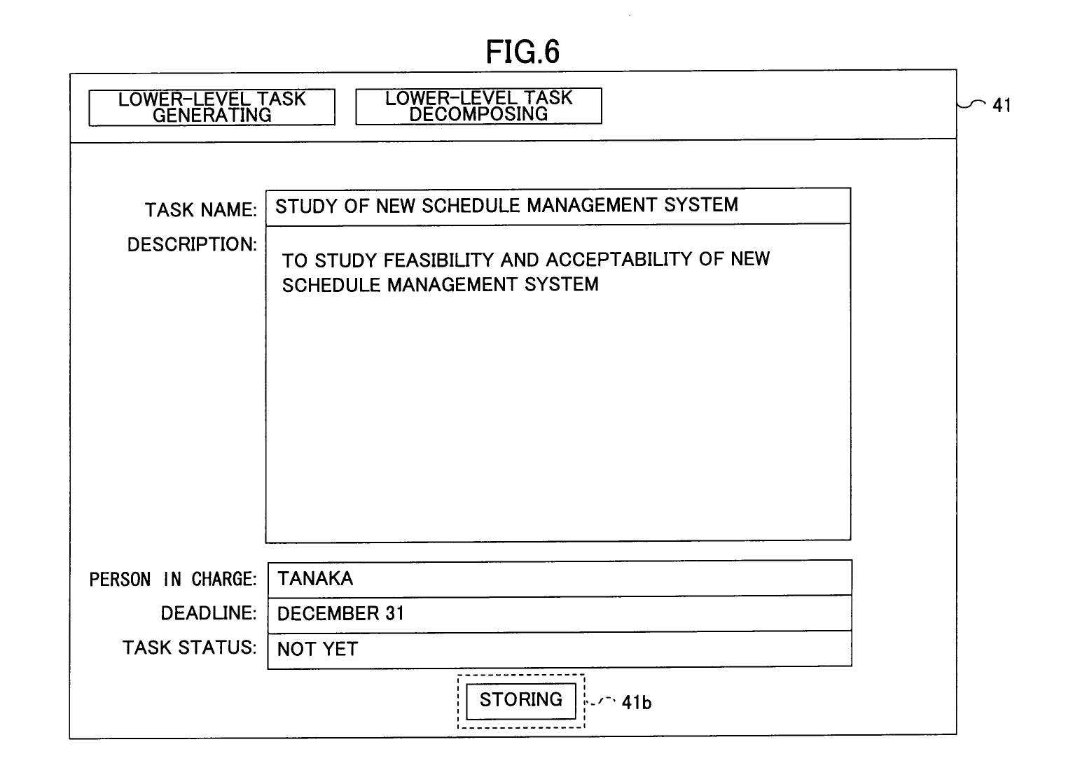

On the other hand, when the storing button 41b in the input UI 41 is selected by the user (refer to FIG. 6), the task management device 100 causes the task information generating unit 22 to generate the task information 32 from the task definition data 31 in response to the request. However, the task information generating unit 22 does not perform the syntactic analysis of the task definition data 31, the extraction of information concerning the tasks, and the addition of identification information and information concerning hierarchical structure mentioned above.

Finally, the task management device 100 causes the task information storing unit 23 to store the task information 32 (temporarily stored in the RAM of the main storage unit 12) generated by the task information generating unit 22, in the predetermined area in the non-volatile memory unit, such as the secondary storage unit 13.

Accordingly, through the above-mentioned procedures of the task management function, the task management device 100 of this embodiment allows the user to easily add and register a task by simple operation in the task management which manages a plurality of tasks arranged in a hierarchical structure.

The respective units explained above with reference to FIGS. 2-5 are realized by performing task management operation in the task management device.

Some examples of task management operation of the task management function provided in the task management device 100 of this embodiment actually performed by the user will be explained with reference to FIGS. 6-14.

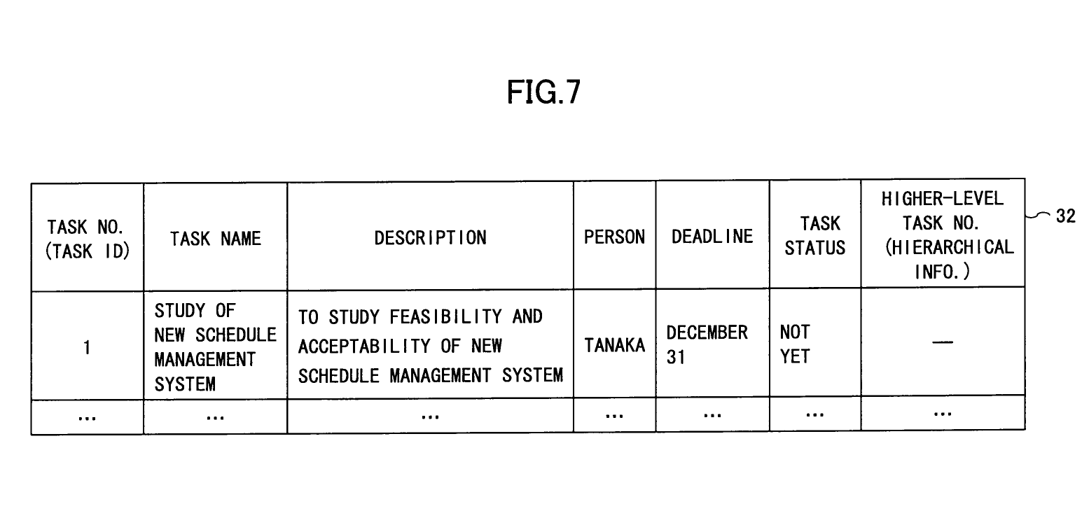

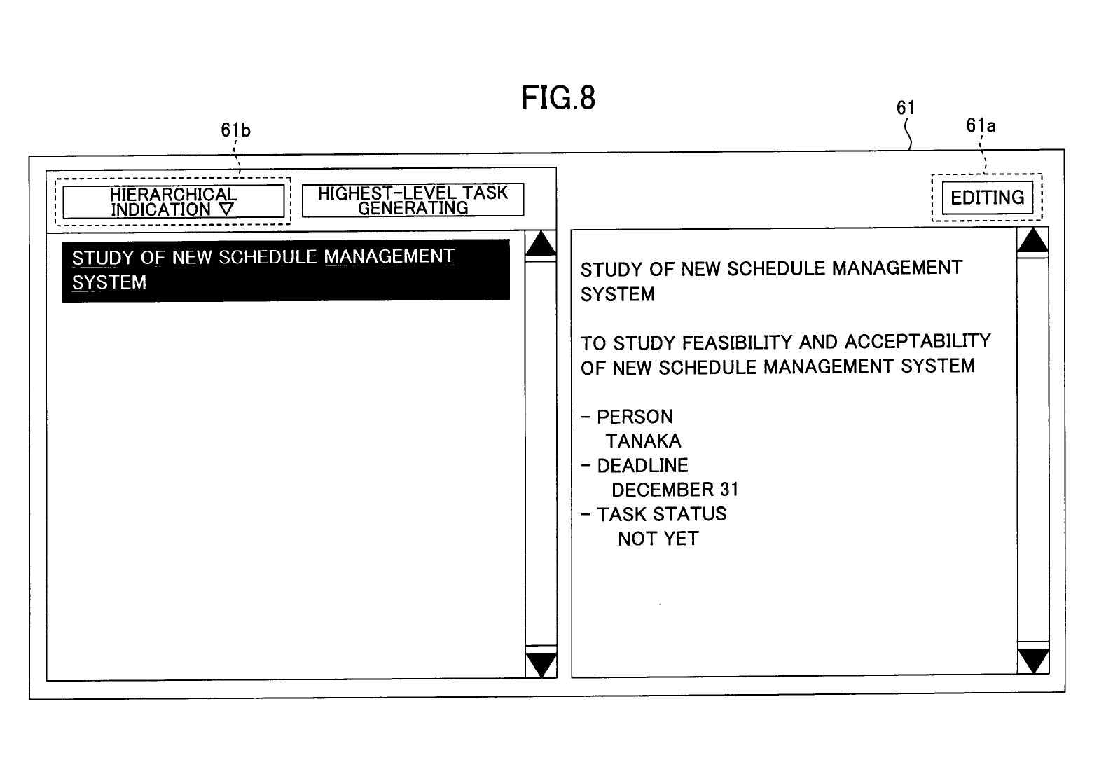

FIG. 6 shows an example of task management operation (input of task definition data) in the first embodiment of the invention. FIG. 7 shows an example of task information generated after the input in the first embodiment of the invention. FIG. 8 shows an example of task management operation (viewing of task information) in the first embodiment of the invention.

As shown in FIG. 6, the task management device 100 of this embodiment provides the user with the input UI 41 by using the task definition data input unit 21.

If the detailed information on the task to be newly registered (or the information on the lower-level tasks (subtasks) which constitute the newly registered task) is indefinite at this time, the remarks describing briefly the contents of the newly registered task are input to a corresponding text box of the item of “description”. It is not necessary that the data of all the items be input. It is permissible for the task management device of this embodiment that only the data in the range that is known at the time of registration be input.

Therefore, in the case of the example of FIG. 6, the task definition data 31 contains only the remarks input to the corresponding text box of the item of “description”.

When the storing button 41b of the input UI 41 is chosen by the user, the task management device 100 receives the input data of the respective items and the request for task registration using the task definition data input unit 21, and transmits the task definition data 31 and the request for task registration to the task information generating unit 22 via the main storage unit 12.

Next, the task management device 100 causes the task information generating unit 22 to simply store the task information 32 (the data corresponding to the respective items of FIG. 7) into the RAM of the main storage unit 12.

In response to the request for task registration, the task management device 100 causes the task information storing unit 23 to register the new task as shown in FIG. 7 by storing the task information 32 received via the main storage unit 12 into the predetermined area of the non-volatile memory unit, such as the secondary storage unit 13.

The task management device 100 provides the user with a user interface 61 (also called viewer UI 61) shown in FIG. 8 for allowing the user to view the information concerning the registered tasks and the hierarchical structure of the registered tasks based on the task information 32 stored in the non-volatile memory unit, such as the secondary storage unit 13.

As a result, the user can update the task information 32 after registration by checking the contents of the task information 32 after registration through the viewer UI 61, and choosing the editing button 61a on the viewer UI 61 if needed.

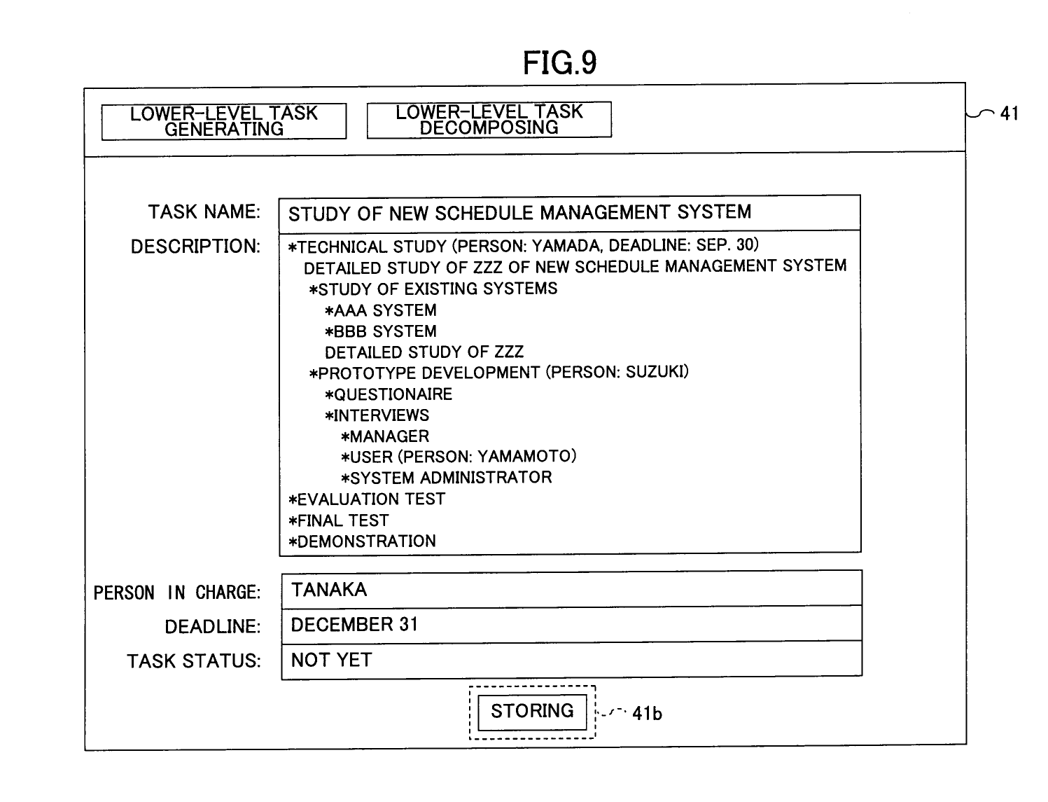

Other examples of task management operation when the user adds a set of lower-level tasks to the existing task (the registered, uncertain task information) and updates the task information in the progress of the project will be explained with reference to FIGS. 9-14.

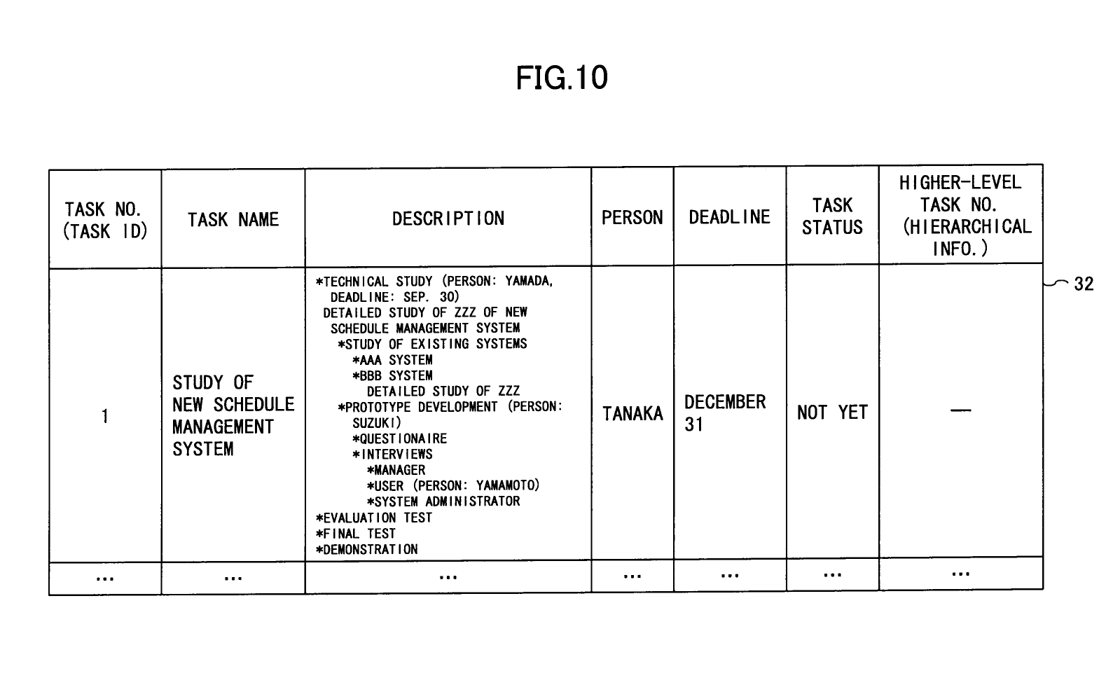

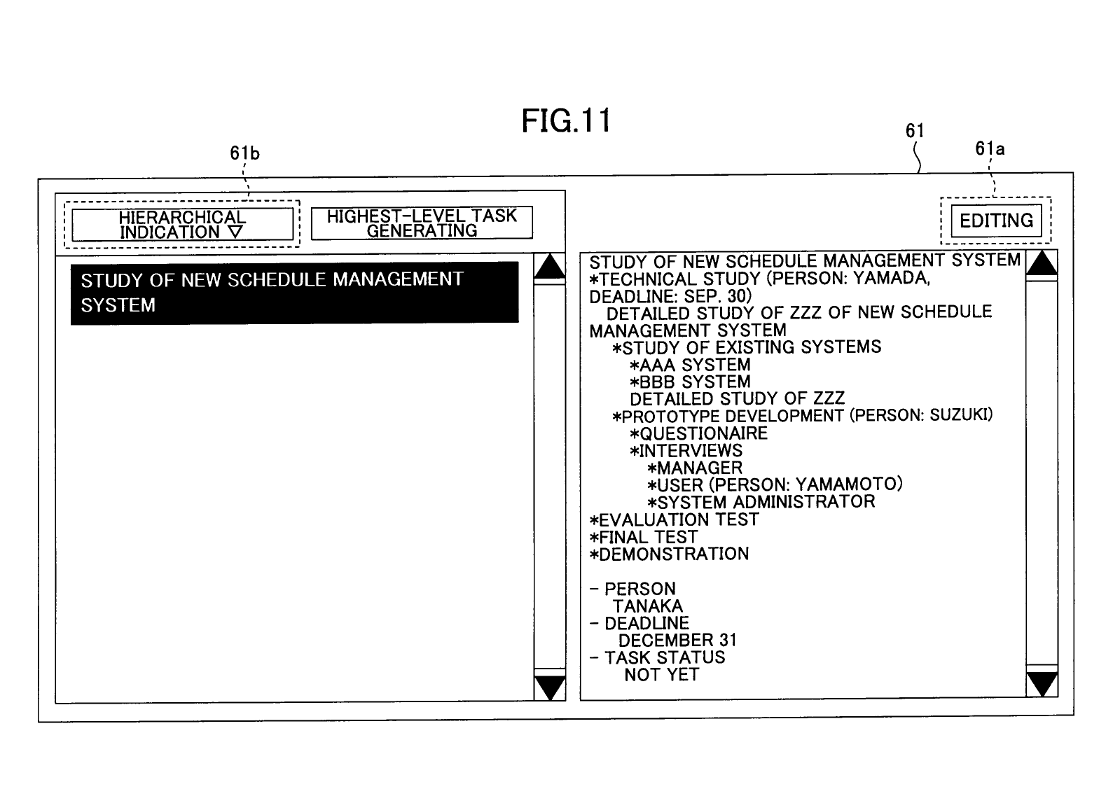

FIG. 9 shows an example of task management operation (input of task definition data 31) in the first embodiment of the invention. FIG. 10 shows an example of task information 32 generated after the input in the first embodiment of the invention. FIG. 11 shows an example of task management operation (viewing of task information 32) in the first embodiment of the invention.

Changes of the non-routine tasks are difficult to foresee, and the whole task composition is difficult to grasp. Since the task composition of the non-routine tasks is fixed gradually through the progress of the project, it is inevitable that the task composition of the non-routine tasks be changed in the progress of the project.

In such a case, the user can easily change the task composition of the non-routine tasks at an appropriate time as follows. The user may view the content of the registered task information 32 using the viewer UI 61 as shown in FIG. 8, select the task to be changed currently (in the example of FIG. 8, the task named “study of new schedule management system”), and click the editing button 61a in the viewer UI 61 so that the user may change or update the content of the selected task of the task information 32 in the input UI 41. The user may input a rough plan (or a draft) of the task definition data 31 as shown in FIG. 9 into the item of “description” of the input UI 41 and click the storing button 41b in the input UI 41.

In this manner, the user may provisionally register the task information 32 containing the rough plan of the task definition data 31 which defines a set of lower-level tasks of the selected task and a hierarchical relationship between the selected task and each of the set of lower-level tasks in accordance with the predetermined rules.

When the storing button 41b in the input UI 41 is clicked by the user as mentioned above, the task management device 100 causes the task information generating unit 22 to generate, without analyzing the input task definition data 31, the task information 32 containing the rough plan of the task definition data 31, as shown in FIG. 10.

The user is allowed to selectively click either the storing button 41b or the lower-level task decomposing button 41a in the input UI 41 provided by the task definition data input unit 21, as shown in FIG. 9. In response to the task registration request from the task definition data input unit 21, the task information generating unit 22 determines whether the information defined in the task definition data 31 is registered as fixed tasks or registered provisionally as unfixed tasks.

When the storing button 41b is chosen by the user, the task information generating unit 22 determines that the user's request is provisional registration of unfixed tasks. Namely, when the storing button 41b is chosen by the user, the task information generating unit 22 follows the task registration request from the task definition data input unit 21, and generates, without analyzing the input task definition data 31, the task information 32 containing the rough plan of the task definition data 31 as shown in FIG. 10. In this case, the task information 32 is not decomposed into lower-level tasks. And the task information 32 includes the originally registered task (the selected task) which contains the rough plan of the task definition data 31. The user may view the content of the thus generated task information 32 in the viewer UI 61 as shown in FIG. 11.

On the other hand, when the lower-level task decomposing button 41a is chosen by the user, the task information generating unit 22 determines that the user's request is registration of fixed tasks. Namely, when the lower-level task decomposing button 41a is chosen, the task information generating unit 22 performs, in accordance with the task registration request from the task definition data input unit 21, the analysis/extraction/addition processing of the above-mentioned Procedure 2 for the input task definition data 31, and generates the task information 32 for every task in the set of lower-level tasks defined in the task definition data 31.

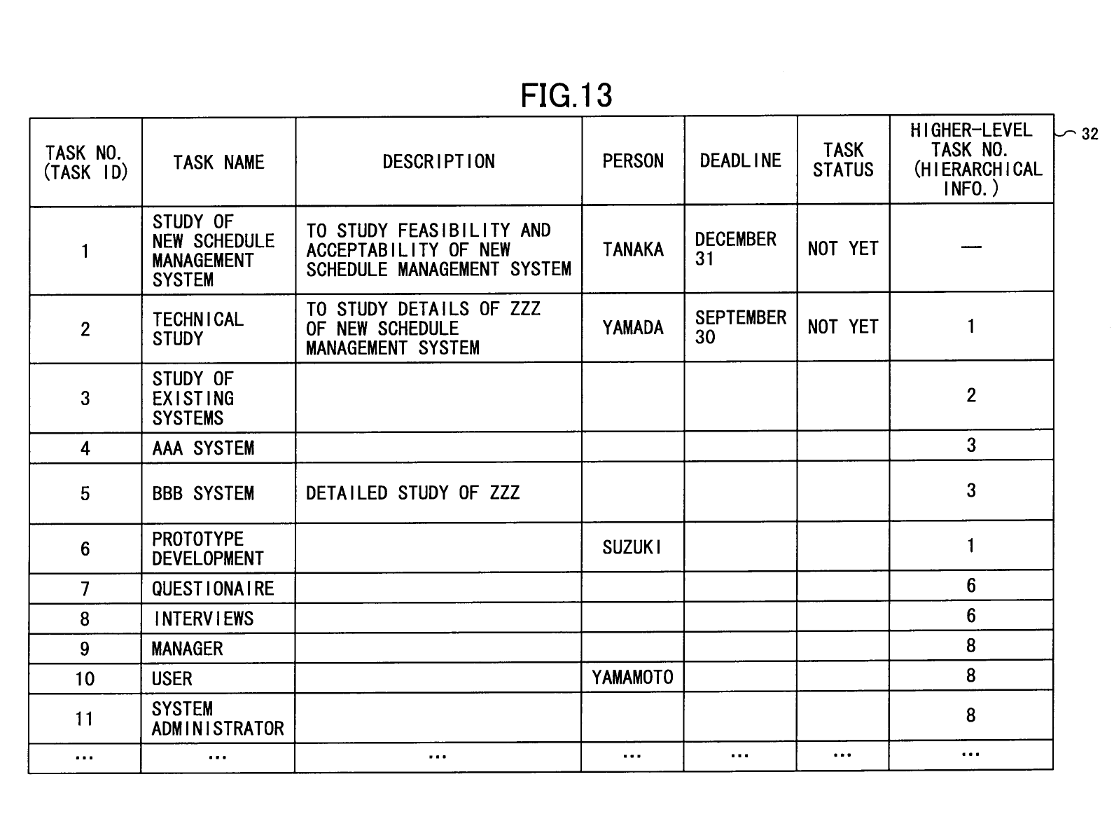

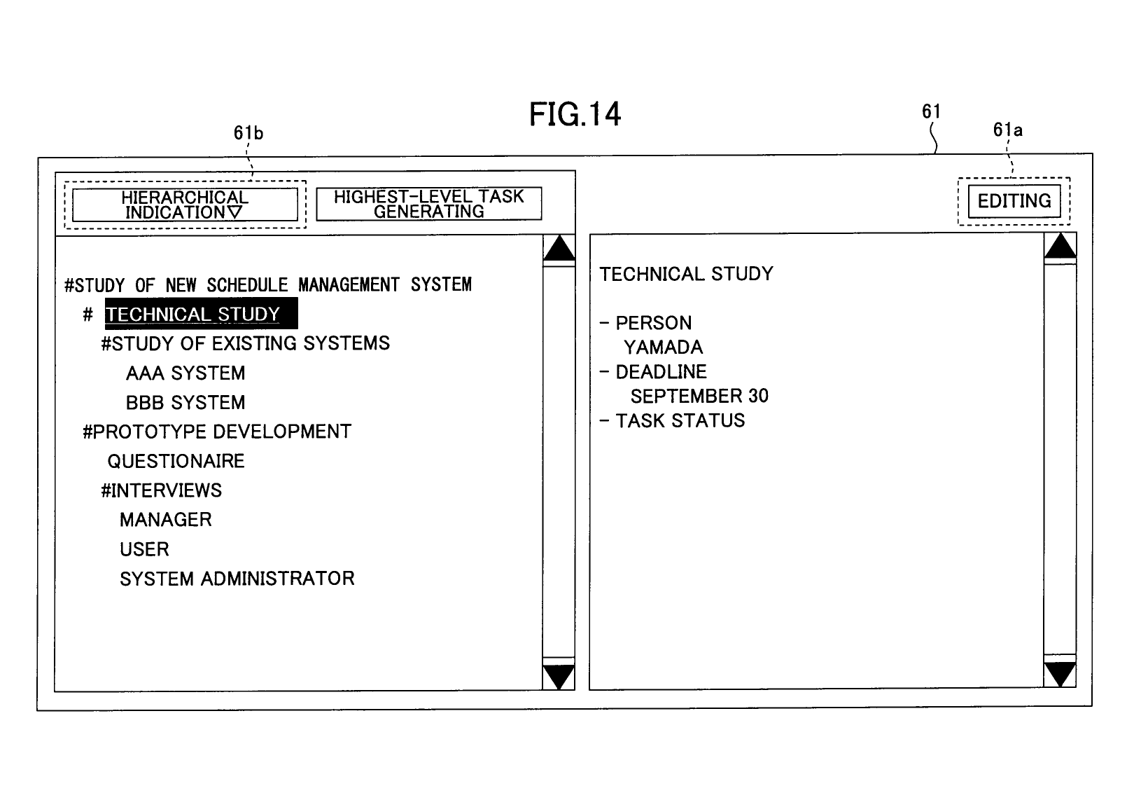

FIG. 12 shows an example of task management operation (decomposing a task into lower-level tasks) in the first embodiment of the invention. FIG. 13 shows an example of task information 32 generated after the decomposing in the first embodiment of the invention. FIG. 14 shows an example of task management operation (viewing of task information 32) in the first embodiment of the invention.

Suppose that the project has progressed and detailed information of unfixed lower-level tasks of the registered task named “study of new schedule management system” is fixed, for example. At this time, the user clicks the editing button 61a in the viewer UI 61, and then the display indication is shifted from the viewer UI 61 to the input UI 41.

In the text box of the item of “description” in the input UI 41 after the shifting, the user selects the range of the task definition data 31 corresponding to the information of the fixed lower-level tasks as shown in FIG. 12. In FIG. 12, the area with the inverted display indication indicates the selected range of the task definition data 31.

After the range selection of the corresponding task definition data 31 is performed, the user clicks the lower-level task decomposing button 41a in the input UI 41. At this time, the task management device 100 of this embodiment follows the task registration request from the task definition data input 21, and transmits the request and the selected task definition data 31 (the information of the lower-level tasks defined as the lower-level tasks of the registered task named “study of new schedule management system”) to the task information generating unit 22 via the main storage unit 12.

Next, the task management device 100 causes the task information generating unit 22 to perform syntactic analysis of the task definition data 31, stored in the RAM of the main storage unit 12, in accordance with the predetermined rules used when defining the information concerning the lower-level tasks of the selected task and the hierarchical relationship between the selected task and each of the lower-level tasks.

As a result, the task management device 100 causes the task information generating unit 22 to extract the information concerning the lower-level tasks (in the case of FIG. 12, the information of ten lower-level tasks including the task named “technical study”) based on the syntactic-analysis result.

The task management device 100 causes the task information generating unit 22 to add the identification information (task number) of each lower-level task to the extraction data based on the syntactic-analysis result, and determine whether a higher-level task exists for each of the extracted lower-level tasks. If it is determined that a higher-level task exists, the information concerning the hierarchical structure (task number of the higher-level task) is added to the extraction data as hierarchical information. The extraction data which is the information concerning the selected task and the lower-level tasks, and the addition data including the identification information of each lower-level task and the information concerning the hierarchical structure are stored temporarily in the RAM of the main storage unit 12.

Next, the task management device 100 causes the task information storing unit 23 to store the task information 32 (extraction data and addition data), received via the main storage unit 12, into the predetermined area in the non-volatile memory unit, such as the secondary storage unit 13, so that the task information 32 containing the lower-level tasks with task numbers (identification numbers) ‘2’ to ‘11’ is registered as shown in FIG. 13.

At this time, as shown in FIG. 14, the task management device 100 provides the user with the viewer UI 61 for viewing the information concerning the plurality of registered tasks and the hierarchical structure between them based on the task information 32, as shown in FIG. 13, stored in the non-volatile memory unit, such as the secondary storage unit 13.

As a result, by choosing the hierarchical indication ∇ button 61b in the viewer UI 61, the user can check the content of the task information 32 after registration, and the hierarchical structure between the tasks, as shown in FIG. 14. The user can update the task information 32 after registration by choosing the editing button 61a in the viewer UI 61, if needed.

In this manner, the task management device 100 of this embodiment allows the user to add and register easily a set of lower-level tasks in the progress of the project by simple operation.

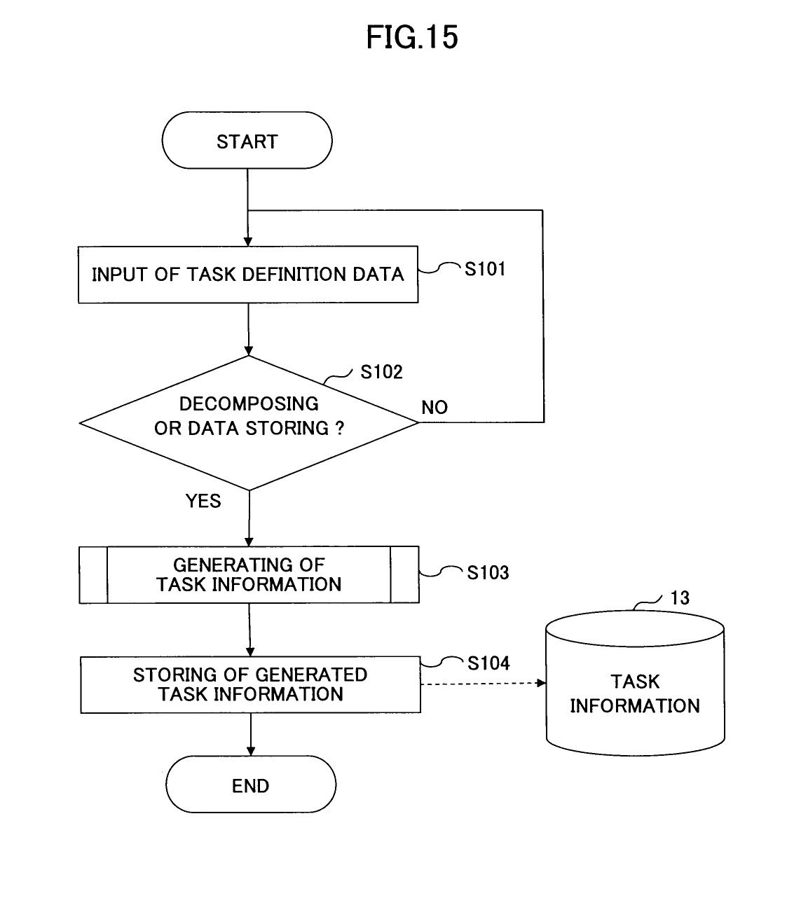

The procedure of the task management function provided in the task management device 100 of this embodiment will be explained with reference to FIG. 15.

FIG. 15 is a flowchart for explaining the fundamental operation procedure performed by the task management of the first embodiment of the invention.

For example, the task management device 100 of this embodiment loads the task management program, which performs the processing of the task management function, stored in the secondary storage unit 13, into the RAM of the main storage unit 12, and executes the loaded program by using the control unit 11. At this time, the following procedure (S101-S104) is performed.

In the task management device 100 of this embodiment, the input UI 41 provided to the user by the task definition data input unit 21 is used by the user to input various data containing the task definition data 31 in which the information concerning the tasks is defined according to the predetermined rules, into the text box in the input UI 41 (S101).

The task management device 100 determines whether the lower-level task decomposing button 41a or the storing button 41b in the input UI 41 is chosen (S102). When the result of the determination at step S102 is negative (NO), the task management device 100 is in a waiting condition until one of the buttons is chosen.

When one of the buttons in the input UI 41 is chosen (the result of the determination at step S102 is YES), the task management device 100 causes the task definition data input unit 21 to transmit the task definition data 31 and the request of data processing to the task information generation processing (the task information storing unit 23) via the main storage unit 12 in accordance with the request of data processing concerning the task registration received together with the data input from the input UI 41.

When the step S102 is completed, the task management device 100 stores the data of the respective items containing the task definition data 31 into the RAM of the main storage unit 12 temporarily.

After syntactic analysis of the task definition data 31 is performed, the task management device 100 causes the task information generating unit 22 to extract the information concerning the task defined and perform the task information generation processing in which the task information 32 in which the identification information of the task (for example, task number) and the information indicating the hierarchical structure (for example, task number of higher-level task) are added to the extracted information concerning the task is generated (S103).

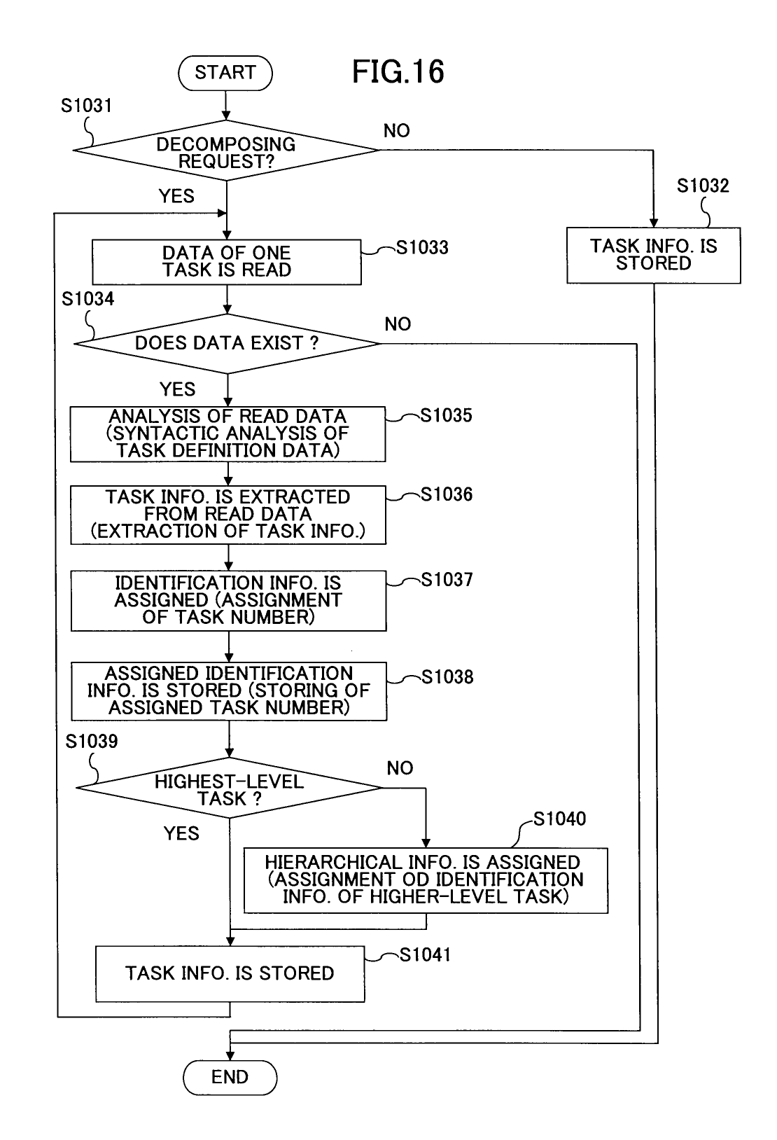

The detailed procedure of the task information generation processing will be explained with reference to FIG. 16.

The task management device 100 stores the task information 32 (temporarily stored in the RAM of the main storage unit 12) generated by task information generation processing, into the non-volatile memory unit, such as the secondary storage unit 13 (S104).

At this time, the task number (identification information identifying the task) assigned lastly to the information concerning the tasks and temporarily stored in the RAM of the main storage unit 12 after the end of the data processing, which will be subsequently needed in the task information generation processing of FIG. 16 in order to perform the data processing of the input task definition data 31 is also stored in the non-volatile memory unit, such as the secondary storage unit 13.

Next, the task information generation processing which generates the task information 32 from the task definition data 31 in the procedure of FIG. 15 will be explained with reference to FIG. 16.

FIG. 16 is a flowchart for explaining the task information generation processing in the first embodiment of the invention. The task information generation processing of FIG. 16 is performed in the step S103 in FIG. 15.

Upon start of the task information generation processing of FIG. 16, it is determined whether the lower-level task decomposing button 41a is chosen at step S102 (S1031).

When the storing button 41b in the input UI 41 is chosen (the result of the determination at step S102 is YES), the result of the determination at step S1031 is negative (NO), the control shifts to step S1032. In accordance with the request of data processing received from the task definition data input unit 21, the task management device 100 of this embodiment causes the task information generating unit 22 to generate task information 32 for registration, based on the task definition data 31 stored in the RAM of the main storage unit 12 by the task definition data input unit 21. At this time, the task information generating unit 22 stores the generated task information 32 into the RAM of the main storage unit 12 temporarily (S1032). The procedure of FIG. 16 is terminated.

On the other hand, when the lower-level task decomposing button 41a in the input UI 41 is chosen (the result of the determination at step S102 is YES), the result of the determination at step S1031 is affirmative (YES), the control shifts to step S1033. In accordance with the request of data processing received from the task definition data input unit 21, the task management device 100 of this embodiment causes the task information generating unit 22 to perform syntactic analysis of the input task definition data 31 according to the predetermined rules used when defining the information concerning the tasks. At this time, the task information generating unit 22 reads the task definition rules, defining the contents of lower-level tasks, from the secondary storage unit 13 into the storage unit 12. The task information generating unit 22 performs syntactic analysis of the task definition data 31 based on the read task definition rules.

First, the task management device 100 reads the task definition data 31 stored in the RAM of the main storage unit 12 (S1033). At this time, in the reading of first data, the task management device 100 reads a character string from the head-end point of the data until a line feed code (for example, CR or LF) appears. In the reading of second or subsequent data, the task management device 100 reads a character string from the data point immediately after the first line feed until the following line feed code appears.

When reading the task definition data 31, the task management device 100 determines whether the remaining data (character string) to be subsequently read exists, based on the end-of-file code (EOF), etc. in the data (S1034).

When it is determined at step S1034 that no data to be subsequently read exists (NO), the task information generation processing is terminated assuming that the syntactic analysis of the task definition data 31 is completed.

When it is determined at step S1034 that the data to be subsequently read exists (YES), the task management device 100 performs syntactic analysis of the data or character string in accordance with the predetermined rules used when defining the information concerning the task and the information indicating the hierarchical relationship between the tasks (S1035).

The task management device 100 acquires the information indicating the hierarchical relationship between the tasks (for example, information indicating a task level) based on the result of syntactic analysis of the character code (for example, indentation or space) from the head-end point of the character string.

The task management device 100 extracts the information concerning the task based on the result of syntactic analysis of the pattern of the character string (for example, “*task name (person in charge: Name, deadline: Date)”) (S1036). These items of the extracted information are stored in the RAM of the main storage unit 12 temporarily.

For example, based on the task number lastly added, temporarily stored in the RAM of the main storage unit 12 or stored in the non-volatile memory unit, such as the secondary storage unit 13, the task management device 100 adds the task number which identifies the task as the object of syntactic analysis to the extracted information concerning the task (S1037).

The task management device 100 temporarily stores the task number assigned in the step S1035 into the RAM of the main storage unit 12 as the lastly added task number (S1038).

Based on the information indicating the hierarchical relationship between the tasks (for example, information indicating a task level) obtained by the syntactic analysis, the task management device 100 determines whether the task as the object of syntactic analysis is the highest-level task (S1039).

Only when it is determined at step S1039 that the task as the object of syntactic analysis is not the highest-level task (NO), the task management device 100 adds the largest task number among those of the tasks (higher-level tasks) located in the hierarchy of one higher level of the task as the object of syntactic analysis, to the extracted information concerning the task as the information concerning the hierarchical structure of the task as the object of syntactic analysis (S1040).

As a result, the task management device 100 temporarily stores the task information 32 of the task as the object of syntactic analysis in which the identification information (task number) of the task and the information indicating the hierarchical structure (task number of the higher-level task) are added to the information concerning the task which is extracted based on the syntactic-analysis result, into the RAM of the main storage unit 12 (S1041).

Subsequently, the task management device 100 performs repeatedly the processing of steps S1033-S1041 (the control shifts from step S1041 to step S1033) until there is no data (the object of syntactic analysis) which can be read from the task definition data 31.

In this manner, in the task management device 100 of this embodiment, the task definition data 31 in which the information concerning the task is defined according to the predetermined rules is input through the procedure shown in FIG. 15 and FIG. 16. The task information 32 in which the information concerning the hierarchical structure is added to the extracted information concerning the task based on the syntactic-analysis result of the input task definition data 31 is automatically generated.

The above-described processing of S1033-S1041 is carried out when the lower-level task decomposing button 41a is chosen at the step S102 of FIG. 15. This means that the processing is performed at the time of registering fixed tasks formally. On the other hand, when the storing button 41b is chosen at the step S102 of FIG. 15 (or when registering tasks provisionally), syntactic analysis of the task definition data 31 is not performed, the data in the task definition data 31 is generated as the task information 32, and the generated data is simply stored into the RAM of the main storage unit 12 temporarily.

As mentioned above, the task management device 100 of this embodiment allows the user to easily add and register a task by simple operation in the task management which manages a plurality of tasks arranged in a hierarchical structure.

Although the invention has been explained based on the first embodiment, the task management function provided in the task management device 100 of the first embodiment of the invention may be realized by executing a program in which the respective procedures of the first embodiment are encoded in the programming language in conformity with the hardware environment (platform) by using a computer.

Therefore, the program (task management program) which performs the task management function provided in the task management device 100 of the first embodiment of the invention may be recorded in a computer-readable storage medium.

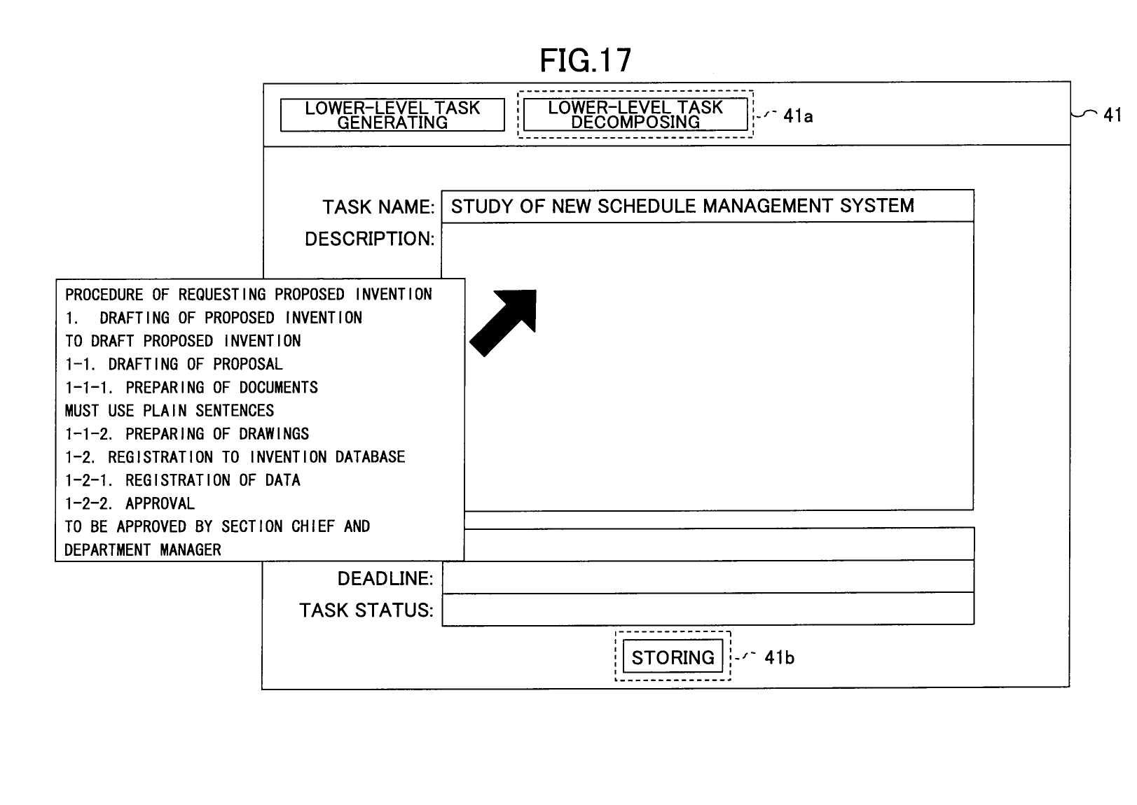

FIG. 17 shows an example of a task definition data input in a modification of the first embodiment of the invention.

In the first embodiment mentioned above, “the predetermined rules” are an example of task definition rules which defines the information concerning the tasks and the information indicating the hierarchical relationship between the tasks in the task definition data 31. However, the present invention is not limited to this embodiment.

Alternatively, the information concerning the tasks may be defined according to the rules as shown in FIG. 17, so as to allow the information concerning the tasks and the hierarchical relationship between tasks to be analyzed by the task information generating unit 22.

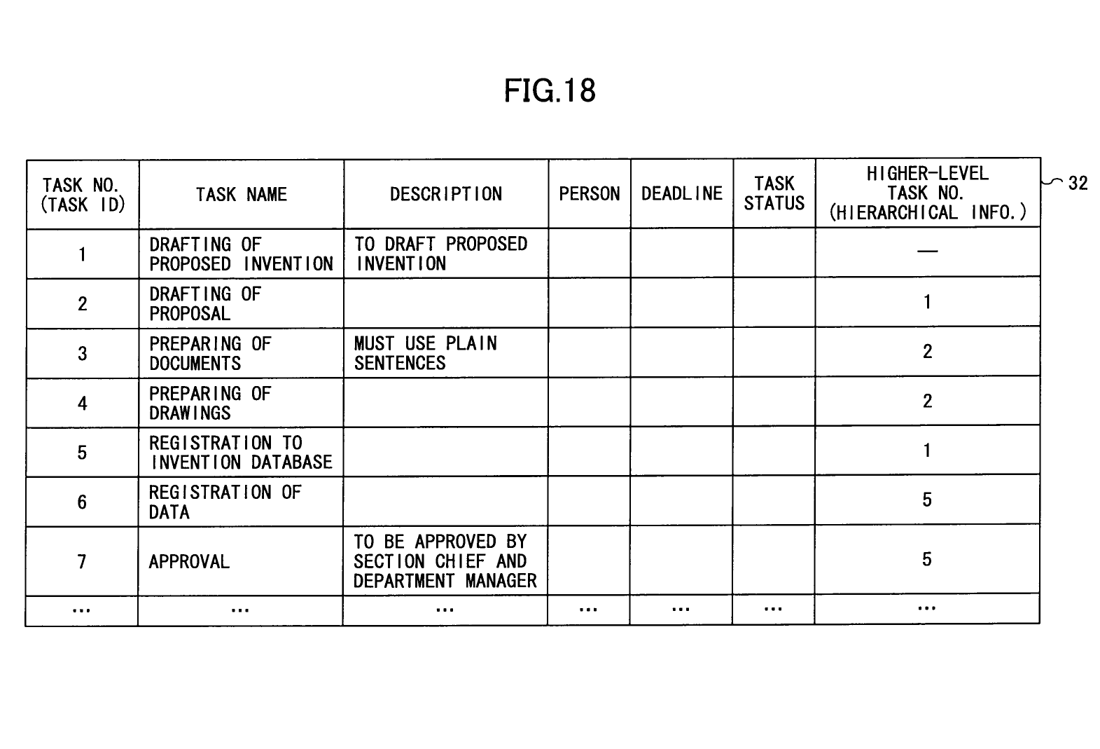

FIG. 18 shows an example of task information 32 generated in a modification of the first embodiment of the invention.

When the task definition data 31 according to the rules of FIG. 17 is input, the task management device 100 of this modification causes the task information generating unit 22 to generate the task information 32 as shown in FIG. 18.

The method of inputting the task definition data 31 through the input UI 41 in the previously described first embodiment is an example of the task definition data input unit 21 which inputs the task definition data 31. However, the present invention is not limited to this embodiment.

Alternatively, the task definition data input unit 21 of this modification may input the task definition data 31 into the task management device 100 in accordance with the following data input method.

A predefined task definition file in which the information concerning a group of tasks which are to be registered by the user and the information indicating the hierarchical relationship between the tasks are defined according to the predetermined rules is generated and the generated task definition file is stored beforehand in a non-volatile memory unit, such as the secondary storage unit 13.

As a result, based on the file name specified when a request for registration or addition of the tasks is received, the task definition data input unit 21 is caused to retrieve the task definition file stored in the non-volatile memory unit, such as the secondary storage unit 13, and the task definition data 31 is input by reading the data of the task definition file.

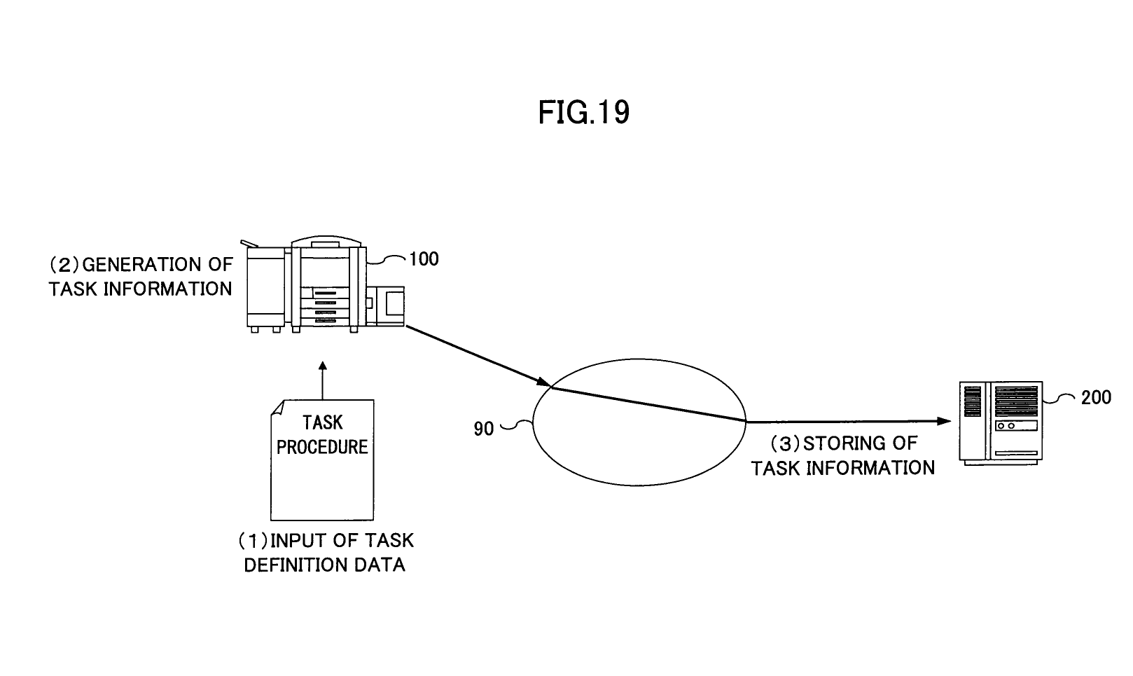

FIG. 19 shows an example of a task management system in a modification of the first embodiment of the invention. In the task management system of FIG. 19, the user can add and register a task by simple operation according to the predetermined rules, based on a task procedure document, such as a memorandum written in business, in which the information concerning the tasks and the information indicating the hierarchical relationship between the tasks are written by hand.

The task management system shown in FIG. 19 is a system which includes a task management device 100 (for example, an image forming device, such as a copier) having a scanner function of optically reading a document (task procedure document), and a server 200 having a database function of storing the task information 32, which are interconnected by a network 90.

In the task management system of this modification, the task procedure document in which the information concerning the tasks and the information indicating the hierarchical relationship between the tasks are written according to the predetermined rules is optically read by using the scanner function of the task management device 100, and a task definition file of a text format is automatically generated from the read image data by using an OCR (optical character reader) function.

Next, in the task management system, the task management device 100 is caused to read the data from the task definition file, generate the task information 32 based on a syntactic-analysis result, and transmit the generated task information 32 to the server 200 through the network 90.

As a result, in the task management system, the server 200 is caused to store the task information 32 received from the task management device 100 into the predetermined areas of the database function provided in the server 200.

In this manner, in the task management system of this modification, the user is allowed to easily add and register a task by simple operation with respect to the information concerning the tasks and the information indicating the hierarchical relationship between the tasks which are written on paper, such as a memorandum written in business.

The present invention is not limited to the above-described embodiments, and variations and modifications may be made without departing from the scope of the present invention.

The present application is based on and claims the benefit of priority of Japanese patent application No. 2007-071604, filed on Mar. 19, 2007, the contents of which are incorporated by reference in their entirety.

What is claimed is:

1. A task management device which manages a plurality of tasks arranged in a hierarchical structure and stored in a storage unit, the task management device comprising:
a task definition data input unit configured to input task definition data which describes contents of a task;
a task information generating unit configured to generate task information of the task from the task definition data input by the task definition data input unit;
a task information storing unit configured to store the task information generated by the task information generating unit, into the storage unit; and
a receiving unit configured to receive a request for generating a set of lower-level tasks from the task information,
wherein, when the request is received by the receiving unit, the task information generating unit generates task information of each of the set of lower-level tasks, based on a result of analysis of the task definition data for the task information which analysis is performed in accordance with predetermined rules used to define contents of each lower-level task.

2. The task management device according to claim 1, wherein the task information generating unit is configured to add information identifying each lower-level task to task information of the lower-level task containing a character string which is extracted from the task definition data and indicates contents of the lower-level task, so that the task information of each lower-level task is generated.

3. The task management device according to claim 2, wherein the predetermined rules include information indicating a hierarchical relationship between lower-level tasks, and the task information generating unit is configured to add information indicating a hierarchical relationship between the task and each low-level task to the task information of the lower-level task containing the character string, based on the information included in the predetermined rules, so that the task information of each lower-level task is generated.

4. The task management device according to claim 1, wherein the receiving unit is configured to receive a request having a selected range of the task definition data for generating a set of lower-level tasks, and the task information generating unit is configured to perform analysis of the selected range of the task definition data in accordance with the predetermined rules.

5. A task management method which manages a plurality of tasks arranged in a hierarchical structure and stored in a storage unit, the method comprising the steps of:
inputting task definition data which describes contents of a task;
generating task information of the task from the input task definition data;
storing the generated task information into the storage unit; and
receiving a request for generating a set of lower-level tasks from the task information,
wherein, when the request is received in the receiving step, task information of each of the set of lower-level tasks is generated in the generating step based on a result of analysis of the task definition data for the task information which analysis is performed in accordance with predetermined rules used to define contents of each lower-level task.

6. A computer-readable program which, when executed by a computer, causes the computer to perform a task management method which manages a plurality of tasks arranged in a hierarchical structure and stored in a storage unit, the method comprising the steps of:
inputting task definition data which describes contents of a task;
generating task information of the task from the input task definition data;
storing the generated task information into the storage unit; and
receiving a request for generating a set of lower-level tasks from the task information,
wherein, when the request is received in the receiving step, task information of each of the set of lower-level tasks is generated in the generating step based on a result of analysis of the task definition data for the task information which analysis is performed in accordance with predetermined rules used to define contents of each lower-level task.
